(19) United States
(12) Patent Application Publication
(10) Pub. No.: US 2006/0082094 A1
(43) Pub. Date: Apr. 20, 2006

(54) Independent wheel suspension system

(76) Inventor: Christian Mosler, Stuttgart (DE)

Correspondence Address: KLAUS J. BACH & ASSOCIATES;PATENT AND TRADEMARKS, 4407 TWIN OAKS DRIVE, MURRYSVILLE, PA, 15668, US

(21) Appl. No.: 11/274,936

(22) Filed: Nov. 15, 2005

Related U.S. Application Data
(63) Continuation-in-part of application No. PCT/EP04/03215, filed on Mar. 26, 2004.

(30) Foreign Application Priority Data
May 15, 2003 (DE) 103 21 877.7

(51) Int. Cl. B60G 9/02

(52) U.S. Cl. 280/124.116

(57) ABSTRACT

In an independent wheel suspension system comprising a strut supporting the wheel of a vehicle and including a wheel carrier mounted on the strut by a plurality of elastic bearings, at least one of the elastic bearings is disposed in front of the axis of rotation of the wheel and has a pivot axis which extends in a vertical plane at an angle of 20° to 50° with respect to the driving direction of the vehicle, and, behind the axis of rotation of the wheel, the wheel carrier is mounted to the strut via an oscillating plate extending in a plane oriented at an angle of 90° to the 110° relative to the driving direction by elastic pivot bearings whose center lines extend perpendicularly to the oscillating plate.

This is a Continuation-In-Part Application of International Application PCT/EP2004/003215 filed Mar. 26, 2004 and claiming the priority of German application 103 21 877.7 filed May 15, 2003.

### BACKGROUND OF THE INVENTION

The invention relates to an independent wheel suspension system with an inclined, longitudinal or composite strut mounted on a vehicle body which guides the wheel and has a wheel carrier which is supported on the strut by a plurality of elastic pivot bearings, the elastic pivoting bearings comprising, at least in regions, two concentric rings or a ring and a bolt, between which an elastomer body is disposed.

DE 198 32 384 C1 discloses such an independent wheel suspension, wherein a wheel carrier can be pivoted about an approximately vertical axis, which extends behind the wheel axis in relation to the driving direction. The wheel carrier is supported elastically on the inclined, longitudinal or composite strut in front of the wheel axis in the vehicle transverse direction. As the pivoting mount is realized by a dimensionally rigid four-bar mechanism, the independent suspension system tends toward longitudinal oscillations which impair the driving comfort, in particular in connection with active brake control systems.

Furthermore, FR 2 726 227 A1 discloses an independent wheel suspension system, wherein the wheel carrier is supported on the strut via at least one elastic control bearing, the bearing journal of which lies with its center line in a vertical plane which extends at an angle of from 20° to 50° with respect to the driving direction. As viewed in the driving direction, the wheel carrier is mounted movably on the strut via a pivoting bearing disposed behind the wheel rotational axis and above the horizontal wheel center transverse plane. Furthermore, as viewed in the driving direction behind the wheel rotational axis and below the horizontal wheel center transverse plane, the wheel carrier is articulated movably on the strut via a support bearing which has a center line that is at least approximately parallel to the driving direction.

Furthermore, JP 2002 012015 A discloses a composite strut axle, in which the wheel carrier is mounted on the axle, inter alia, by an oscillating plate. However, the center lines of the elastomer bodies of the oscillating plate pivot bearings are oriented perpendicularly with respect to the roadway surface.

It is therefore the object of the present invention to provide an independent wheel suspension system with a separately elastically mounted wheel carrier, such that the driving comfort of the vehicle is improved when the vehicle is subjected to lateral, longitudinal and vertical forces.

### SUMMARY OF THE INVENTION

In an independent wheel suspension system comprising a strut supporting the wheel of a vehicle and including a wheel carrier mounted on the strut by a plurality of elastic bearings, at least one of the elastic bearings is disposed in front of the axis of rotation of the wheel and has a pivot axis which extends in a vertical plane at an angle of 20° to 50° with respect to the driving direction of the vehicle, and, behind the axis of rotation of the wheel, the wheel carrier is mounted to the strut via an oscillating plate extending in a plane oriented at an angle of 90° to the 110° relative to the driving direction by elastic pivot bearings whose center lines extend perpendicularly to the oscillating plate.

For this purpose, in the driving direction in front of the wheel rotational axis, the wheel carrier is supported on the strut via at least one elastic control bearing, the bearing journal of which lies with its center line in a vertical plane which extends at an angle of from 30° to 50° with respect to the driving direction. In the driving direction behind the wheel rotational axis, the wheel carrier is mounted pivotably on the strut via an oscillating plate, which has an imaginary center plane extending at an angle of from 90° to 110° with respect to the vehicle driving direction. Four elastic support bearings are integrated into the oscillating plate, for supporting the wheel carrier on the strut via the oscillating plate.

The wheel carrier mount is very simple in structural terms but improves the riding comfort as a result of the use of the oscillating plate. The oscillating plate which is, for example, of rectangular and symmetrical design can be used on every vehicle side. The oscillating plate which is pre-mounted with the rubber bearings can be screwed to the strut and the wheel carrier without problems and free of stresses. The vertical tolerance compensation is carried out via the rubber elements or via the elastomer bodies. In addition, the oscillating plate requires little space in the rim region, even if used in connection with a drive axle. It requires even less space if it is of crescent-shaped or bent-over configuration, as viewed from the side.

The invention will become more readily apparent from the following description of an exemplary embodiment which is shown diagrammatically in the accompanying drawings.

### BRIEF DESCRIPTION OF THE DRAWINGS

FIG. 1 shows an independent wheel suspension system in a perspective view;

FIG. 2 shows the independent wheel suspension system of FIG. 1 rotated by 180°;

FIG. 3: is a plan view of the independent suspension system;

FIG. 4: is a side view of the arrangement shown in FIG. 1;

FIG. 5: is a rear view of the arrangement shown in FIG. 1; and

FIG. 6: shows an independent suspension system in a perspective view, with a curved oscillating plate.

### DESCRIPTION OF AN EXEMPLARY EMBODIMENT

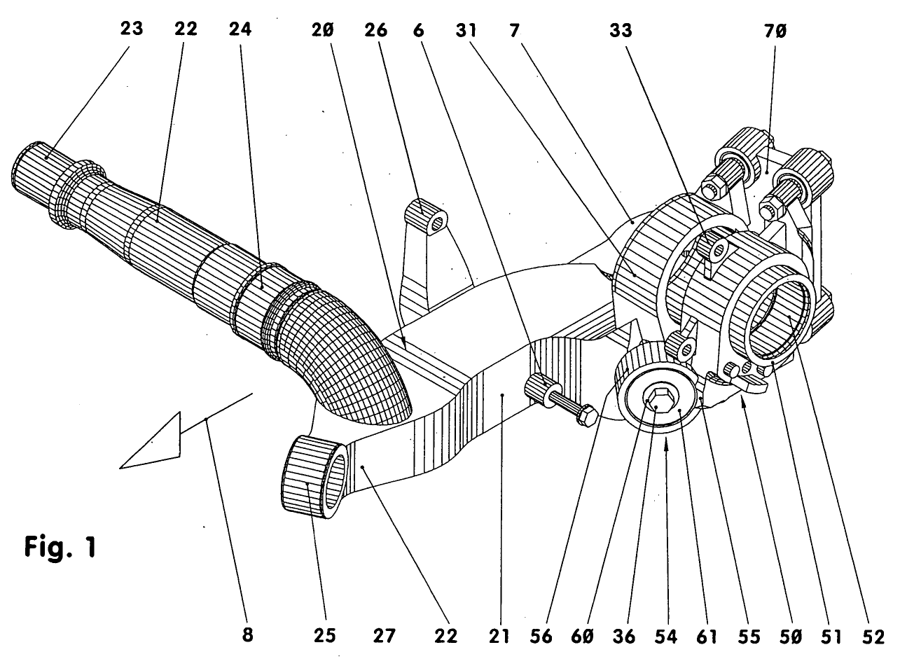

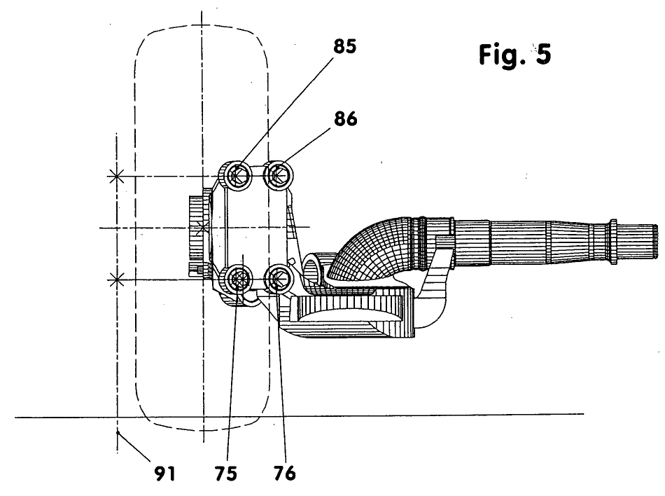

The independent wheel suspension system illustrated in FIGS. 1 to 5 represents, by way of example, the left-hand part of an optionally driven composite strut axle with longitudinal struts (20) which can be pivoted with respect to a vehicle body in pivoting bearing points. A wheel carrier (50) is mounted elastically on the longitudinal strut (20).

In the exemplary embodiment, the longitudinal strut (20) comprises a center part (21) on which a pivot pin (22) is arranged in front of the wheel rotational axis (2). The pivot pin (22) which is oriented parallel to the roadway surface (9) and perpendicularly with respect to the driving direction has two pivot bearing points (23) and (24), via which it is mounted by friction bearings, non-friction bearings or elastomer bearing bodies on a composite strut tube or the pivot pin of the right-hand strut. The relative rotation between the two struts is restricted by a stabilizer (not shown). The stabilizer is connected to the strut (20) via a stabilizer bearing (26). At the front end, the composite strut axle is mounted on the vehicle body via a pivot bearing (25). The respective pivoting bearing (25) lies in front of the center line of the pivot pin (22).

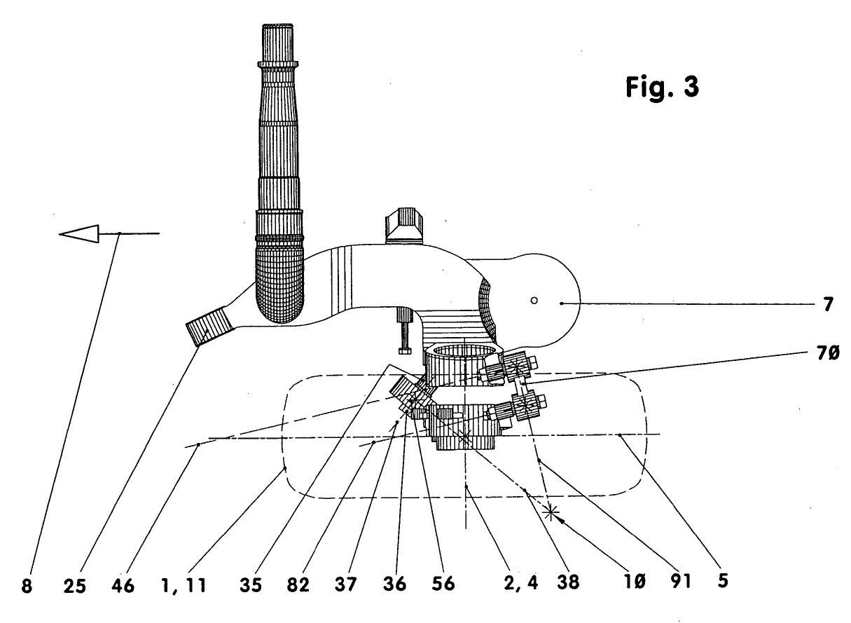

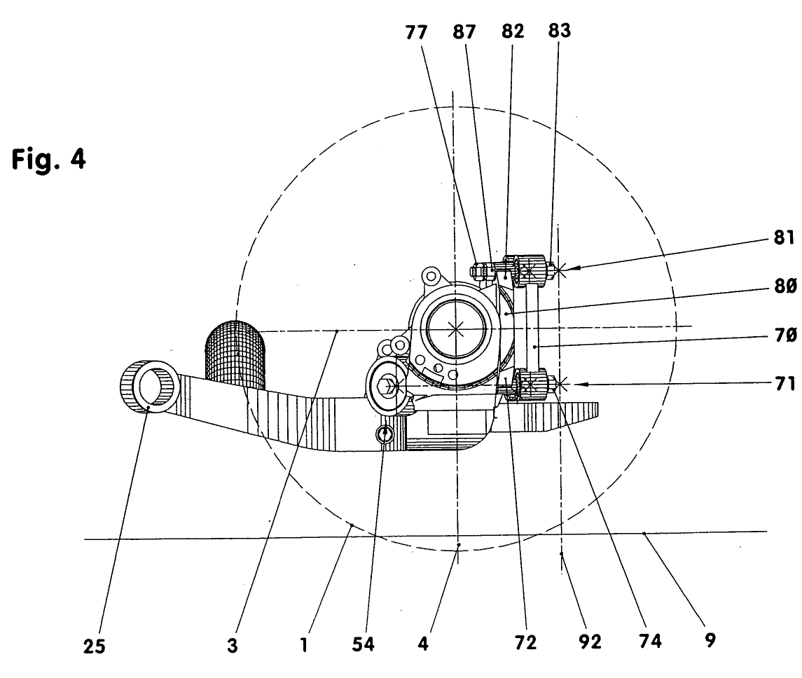

As shown in FIG. 4, the geometric center of the pivot bearing (25) lies higher than the geometric centers of the pivoting bearing points (23, 24) and in front of the bearing points (23, 24) in the driving direction (8), cf. FIG. 3. The elastomer body which is provided for the pivoting bearing (25) is, for example, a rubber element which is rigid longitudinally and transversely.

In the region of the wheel rotational axis (2), the center part (21) of the strut (20) is angled toward the vehicle outer side. A wheel carrier mount body (31) is integrally formed with the strut (20) at its angled end. The wheel carrier mount body (31) is essentially a short tube, with an opening center line which coincides with the wheel rotational axis (2) or is situated at least in its immediate vicinity. The level of the upper contour of the center part (21) lies below the lowest point of the central opening (32) of the wheel carrier mount body (31).

The wheel carrier (50) is mounted elastically on the wheel carrier mount body (31) at three points. These points are the control bearing (54), the lower oscillating plate mount (71) and the upper oscillating plate mount (81). According to FIG. 4, the control bearing (54) lies in front of the vertical wheel center transverse plane (4) and below the horizontal wheel center transverse plane (3). The lower oscillating plate mount (71) is situated behind the vertical wheel center transverse plane (4) and, for example, at the level of the control bearing (54) with regard to the height. At least in the design position, the upper oscillating plate mount (81) lies directly above the lower oscillating plate mount (71) and above the horizontal wheel center transverse plane (3).

A control bearing journal (35) which protrudes toward the front is situated in the region of the transition from the center part (21) to the wheel carrier mount body (31), cf., inter alia, FIG. 3. Said control bearing journal (35) lies parallel to the roadway surface (9) and extends at an angle of from 20° to 50° with the driving direction (8). In FIG. 3, the angle is, for example, 50 degrees. The center line (37) of the control bearing journal (35) lies, for example, approximately 13% of the wheel diameter below the horizontal wheel center transverse plane (3). The tire outer diameter which is sketched with a dashed line in FIGS. 3, 4 and 5 is designated the wheel diameter here. The center line (37) intersects the vertical wheel center transverse plane (4) at a spacing of, for example, 26% of the wheel diameter behind the wheel center longitudinal plane (5).

Two oscillating plate bracket arms (41) and (45) are arranged on the rear side of the wheel carrier mount body (31). The upper bracket arm (45) has a through hole and the lower one has a threaded blind hole. Both holes have in each case a center line (42, 46) which, at least in the design position, is oriented at least approximately parallel to the roadway surface (9). The center lines (42, 46) of the hole of the two oscillating plate bracket arms (41, 45) intersect the wheel center longitudinal plane (5) in front of the wheel rotational axis (2) at an angle of, for example, 13 degrees. The two intersection points lie offset to the front with respect to the vertical wheel center transverse plane (4) by approximately 66% of the wheel diameter. They lie above and below the horizontal wheel center transverse plane (3) in the vertical direction by approximately 13% of the wheel diameter.

The center part (21) of the strut (20) is extended to the rear beyond the vertical wheel center transverse plane (4) counter to the driving direction (8), cf. FIGS. 3 and 4. A spring element which is oriented, for example, perpendicularly with respect to the roadway surface (9) is seated on the strut (20) at this extension, that is, the spring element bearing seat (7). A shock absorber can be articulated in a hinged manner on the strut (20) on a shock absorber bearing journal (6) in front of the vertical wheel center transverse plane (4) and below the horizontal wheel center transverse plane (3). The shock absorber (not shown) which is offset inwardly with respect to the wheel center longitudinal plane (5) by, for example, 28% of the wheel diameter is inclined forward with respect to the vertical, for example by approximately 45°.

The wheel carrier (50) is likewise a substantially tubular component which is elastically mounted on the wheel carrier mount body (31) in an outwardly offset manner. In the design position, it lies virtually congruently in front of the wheel carrier mount body (31). The central opening (52) of the wheel carrier (50) is aligned, for example, with the central hole (32). The spacing between the wheel carrier mount body (31) and the wheel carrier (50) which is offset at least approximately in parallel is approximately 2% of the wheel diameter. The wheel carrier (50) comprises a hub (51), a control bearing bracket arm (55) with a control bearing socket (56), and two oscillating plate bracket arms (72, 82) which are arranged, for example, vertically above one another.

The control bearing bracket arm (55) which is, for example, bent over protrudes in the direction of the control bearing journal (35) (cf. FIG. 3) in such a way that the center line of the control bearing socket (56) is aligned with the center line (37) of the control bearing journal (35). Here, the geometric center of the control bearing socket (56) is situated, for example, approximately 13.5% of the wheel diameter away from the vertical wheel center transverse plane (4). An elastomer body (61) which is accommodated by the control bearing socket (56) and has, for example, a metallic inner bush (60) is arranged on the control bearing journal (35). The elastomer body (61) of the control bearing (54) is of rigid design in the vertical direction. The longitudinal and transverse rigidities are adapted in the horizontal directions to a defined inherent steering behavior. The control bearing thus brings about transverse, longitudinal and vertical support.

Axial bearing disks are optionally arranged as mechanical stops on both sides of the elastomer body (61) and the control bearing socket (56).

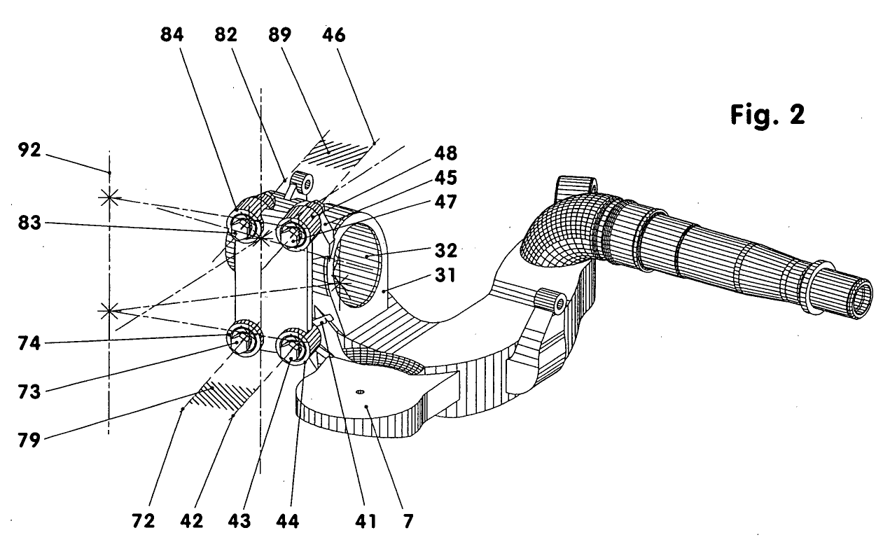

An at least virtually vertical oscillating plate carrier (80) is integrally formed in the rear region of the hub (51). It has a threaded hole at its upper free end and a through hole at its lower free end. The center line (72) of the threaded hole extends, for example, in a plane (79) (cf. FIG. 2) in which also the center line (42) extends parallel to the center line (72). The center line (82) of the through hole which is arranged above it extends also in one plane (89) together with the center line (46). The center lines (82) and (46) extend parallel to one another. The planes (79) and (89) lie parallel to one another and, in the exemplary embodiment, parallel to the roadway surface (9). At the same time, the center lines (72) and (82) define a vertical plane which intersects the wheel center longitudinal plane (5) in front of the wheel rotational axis (2). The line of intersection lies, for example, approximately 18.5% of the wheel diameter in front of the wheel rotational axis (2).

The wheel carrier mount body (31) is connected in a hinged manner to the wheel carrier (50) via an oscillating plate (70) in the region of the oscillating bracket arms (41, 45). In addition, the oscillating plate (70) is arranged adjacent the oscillating bracket arms (41, 45) and the oscillating carrier plate (80). In the design position, the oscillating plate (70) encloses, for example, an angle of approximately 13 degrees with the vertical wheel center transverse plane (4).

The oscillating plate (70) is, for example, a rectangular plate which supports in each case one oscillating plate bearing socket (44, 48, 74, 84) at its four corners (cf. FIG. 2). The bearing sockets (44, 48, 74, 84) have center lines which, at least in the construction position, are congruent with the center lines (42, 46, 72, 82) of the openings which are integrated in the oscillating bracket openings (41, 45) and the oscillating plate carrier (80). The center lines are oriented, for example, perpendicularly with respect to the oscillating plate (70). Elastomer bodies (75, 76, 85, 86) are inserted into the bearing sockets (44, 48, 74, 84) of the oscillating plate (70) via separate bushes, or are vulcanized into them directly. The elastomer bodies (75, 76, 85, 86) have inner bushes which are vulcanized into them and via which they are fastened to the strut (20) and to the wheel carrier (50) by means of screws (43, 47, 73, 83). The inner bushes protrude on both sides a few millimeters beyond the length of the oscillating plate bearing sockets (44, 48, 74, 84) which is measured along the center lines (42, 46, 72, 82).

The center points of the bearing sockets (44, 48) are situated, for example, offset rearward by approximately 18.5% of the wheel diameter behind the vertical wheel center transverse plane (4), while the corresponding offset of the center points of the bearing sockets (74, 84) is, for example, approximately 8% of the wheel diameter. All four center points lie in one center plane (91) of the oscillating plate (70).

In the lower oscillating plate mount (71), the screws (43) and (73) are screwed into the threaded hole of the oscillating plate bracket arm (41) and into the lower threaded hole of the oscillating plate carrier (80). The upper screws (47) and (83) fix the inner bushes of the elastomer bodies (85, 86) in the corresponding through holes of the upper oscillating bracket arm (45) and the oscillating plate carrier by means of the nuts (77) and (87).

By the parts (31) and (50) being screwed by means of the oscillating plate (80), an assembly is produced which is very rigid in the transverse and vertical directions and very compliant in the longitudinal direction.

For example, according to FIG. 3, the momentary center of rotation (10) of the independent suspension system is spaced apart from the wheel center longitudinal plane (5) by approximately 21% of the wheel diameter in the event of braking and lateral forces on the roadway surface (9) on the vehicle outer side outside the contact patch. The momentary center of rotation (10) lies offset to the rear from the vertical wheel center transverse plane (4) by an amount which corresponds to approximately 23% of the wheel diameter. The center of rotation (10) is the point of intersection of a line with the roadway surface (9), the line being formed by the intersection of the normal plane (38) with the center plane (91).

Overall, the wheel carrier (50) is mounted on the strut (20) in such a way that it is very compliant longitudinally behind the wheel center with great vertical and transverse rigidity, in a manner which increases comfort. As a result, the action of the control bearing (54) is influenced only a little by the lower oscillating plate mount (71) and the upper oscillating plate mount (81).

During braking, according to FIG. 4, a torque acts in the counterclockwise direction on the wheel carrier (50) to which the brake caliper is attached on the brake caliper flange (33). The lower, outer screw (73) moves rearward in the elastomer body of the oscillating plate socket (74), counter to the driving direction (8), while the upper, outer screw (83) moves forward in relation to the elastomer body of the oscillating plate socket (84). At the same time, the control bearing socket (56) moves in the direction of the spring element bearing seat (7) (cf. FIG. 3). Under these conditions, the wheel (1) moves in the direction of positive toe.

When traveling around bends, in which the wheel (1) which is shown in FIG. 3 is on the outside, the lateral forces bring about understeer. The wheel (1) pivots about the momentary center of rotation (10) in the direction of positive toe. This is made possible by the elastic guidance of the control bearing socket (56) along the center line (37) of the control bearing journal (35). On account of this elastic compliance and the great transverse rigidity of the oscillating plate mount (71, 81), only the front region of the wheel carrier (50) moves toward the strut (20). As a result of the inclined position of the center line (37) according to FIG. 3, the wheel carrier (50) moves backward in relation to the wheel carrier mount body (31), under the influence of the lateral forces. As a result, the oscillating plate (70) moves in the counterclockwise direction in the plan view, in such a way that the outer oscillating plate sockets (74, 84) are moved backward. As the transverse movement of the control bearing (54) is greater than the transverse displacement of the outer oscillating plate sockets (74, 84), the wheel (1) moves in the direction of positive toe.

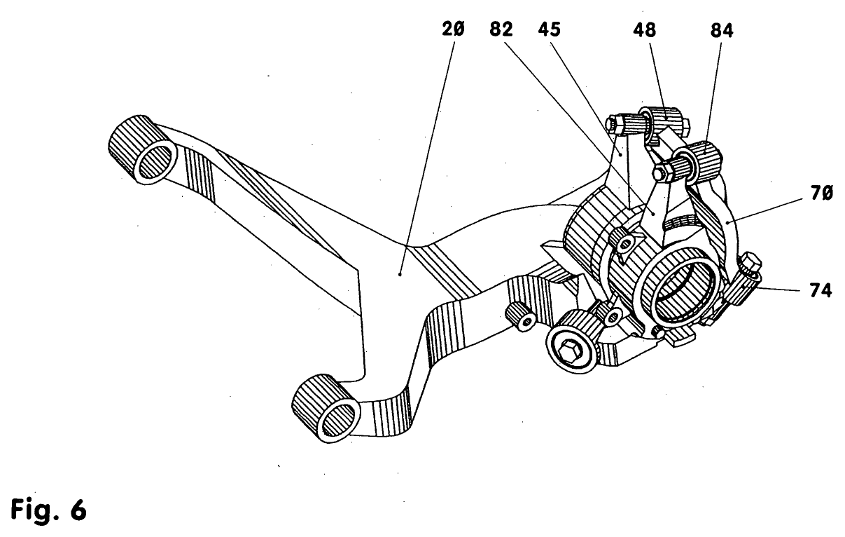

FIG. 6 shows an inclined strut (20) which forks into two strut arms in the driving direction (8). Here, one strut arm is oriented toward the vehicle center, while the other ends in the region in front of the wheel (1). Strut bushes are arranged in each case at the two free ends of the strut arms.

In this exemplary embodiment, the oscillating plate (70) is of curved configuration. Moreover, the center lines of the oscillating bearing sockets are not oriented perpendicularly with respect to the central plane of the oscillating plate, but lie in at least two tangential planes to a cylinder which has the wheel rotational axis (2) as a center line. The center lines of the two upper oscillating plate sockets (48, 84) intersect behind the wheel rotational axis (2) and still within the tire contour (11), while the center lines of the two lower oscillating bearing sockets (44, 74) intersect in front of the wheel rotational axis (2) within the tire contour (11). The center line (37) of the control bearing (54) also extends at an angle of from 10 to 20 degrees with respect to the roadway surface (9). Here, the center line (37) slopes in the direction of the vertical wheel center transverse plane (4).

As a result of the particular arrangement of the center lines of the oscillating bearing sockets (44, 74, 48, 84), the upper oscillating plate mount (81) and the lower oscillating plate mount (71) are of relatively compliant design for rotational movements of the wheel carrier (50) about the wheel rotational axis. The pivoting angle of the oscillating plate (70) is larger than that of the embodiment according to FIGS. 1 to 5.

At the same time, the plane of action of the oscillating plate (70) is tilted by approximately 5 to 10° with respect to the wheel rotational axis (2), that is to say the centers of the upper oscillating bearing sockets (48, 84) lie closer to the vertical wheel center transverse plane than the centers of the lower oscillating bearing sockets (44, 74). As a result, the lever arm accommodating the lateral forces is increased. The longitudinal forces which are generated by the tilting of the oscillating plate (70) are compensated for at least partially by the pivoting of the control bearing (54) in the corresponding opposite direction.

What is claimed is:

1. An independent wheel suspension system comprising a composite strut (20) mounted to a vehicle body and comprising a wheel carrier (50) supporting a vehicle wheel rotatably about an axis (2) and being supported by a plurality of elastic pivot bearings (54, 71, 81) mounted on the strut (20), each elastic pivot bearing including two concentric radially spaced circular members between which an elastomer body is nonreleasably disposed at least in regions thereof,
at least one of the elastic bearings (54) being disposed in the driving direction (8) in front of the wheel rotational axis (2) and having a bearing journal (35) which has a center line (37) disposed in a vertical plane and at an angle of from 20° to 50° with respect to the driving direction (8),
and behind the wheel rotational axis (2), the wheel carrier (31) being mounted pivotably on the strut (20) via an oscillating plate (70) having an imaginary center plane (91) extending at an angle of from 90° to 110° relative to the driving direction (8), and
four elastic pivot bearing sleeves (74, 75; 44, 76; 84, 85; 48, 86) being integrated in the oscillating plate (70), with one part of the fastening elements (73, 43, 83, 47) of said elastic pivoting bearings (74, 75; 44, 76; 84, 85; 48, 86) being fastened to the strut (20) and the other part being fastened to the wheel carrier (31).

2. The independent wheel suspension system as claimed in claim 1, wherein the support bearing center plane (38) which is perpendicular with respect to the center line (37) of the bearing journal (35) intersects the imaginary center plane (91) of the oscillating plate (70) behind the wheel rotational axis (2).

3. The independent wheel suspension system as claimed in claim 2, wherein the line (92) intersects the roadway surface (9) behind the vertical wheel center transverse plane (4) outside the perpendicular projection of the wheel contour (11) onto the roadway surface (9), on the wheel side which faces away from the vehicle.

4. The independent wheel suspension system as claimed in claim 1, wherein at least the parts of the pivoting bearings (74, 75; 44, 76; 84, 85; 48, 86) which are integrated into the oscillating plate (70) have center lines which are oriented at least approximately parallel to the roadway surface (9).

5. The independent wheel suspension system as claimed in claim 1, wherein the oscillating plate (70) is a rectangular, flat plate.

6. The independent wheel suspension system as claimed in claim 1, wherein the pivot bearings (74, 75; 44, 76; 84, 85; 48, 86) which are integrated in the oscillating plate (70) are arranged at the corners of the oscillating plate (70).

7. The independent wheel suspension system as claimed in claim 1, wherein the wheel carrier (50) is of substantially tubular design.

8. The independent wheel suspension system as claimed in claim 1, wherein the bearing journal (35) of the control bearing (54) is part of the strut (20).
